(19) United States
(12) Patent Application Publication
(10) Pub. No.: US 2025/0190396 A1
(43) Pub. Date: Jun. 12, 2025

(54) COMPUTING ARRAY USING GLOBAL NODE PROCESSING

(71) Applicant: International Microsystems Inc., Fremont, CA (US)

(72) Inventor: Peter Arthur Schade, Fremont, CA (US)

(21) Appl. No.: 19/061,647

(22) Filed: Feb. 24, 2025

Related U.S. Application Data
(63) Continuation-in-part of application No. 18/639,452, filed on Apr. 18, 2024.
(60) Provisional application No. 63/496,826, filed on Apr. 18, 2023.

(51) Int. Cl. G06F 15/80

(52) U.S. Cl. CPC G06F 15/80

(57) ABSTRACT

The present invention describes a multi-tiered parallel array computer consisting of a main processing unit and its software manager connected to an array of nodes consisting of node processing devices with associated software managers wherein each node has an attached secondary array consisting of a combination of processing devices and or storage devices. Means are provided using the software managers that allow varying modes of data access include exclusive data access (or “Disjoint Access”) to the secondary array storage devices by the main processing unit or any or node processing devices. Also, enhancing speed devices such as cross-point switches may be used to provide maximize processor efficiency. The present invention is particularly suited for artificial intelligence machine learning computation or complex edge computing where multiple processors are used to provide low latency processing of large data sets and where the processors and data storage are housed in a single server case.

### CROSS-REFERENCE

This application is a Continuation-in-part of U.S. Ser. No. 18/639,452, filed Apr. 18, 2024; which claims priority from U.S. Provisional Application No. 63/496,826, filed Apr. 18, 2023, which are incorporated herein by reference.

### FIELD OF INVENTION

The present invention relates to the design of a modular parallel computer in a single case which we call a “GAP” (for “Global Array Processor”) server that is capable of holding a large data set and associated processing devices. The GAP server is capable of processing data for many High Performance Computing, (i.e., “HPC”), or complex edge computing tasks such as used in Artificial Intelligence (or “AI”) machine learning applications. The GAP server presented is especially suited for being housed in a low height 1U (i.e., 1U=1.75 in) or 2U high 19″ rack mountable server case or smaller.

### BACKGROUND

AI machine learning is becoming a widely used method of increasing the productivity of many human endeavors. For AI to be affective, a large machine data sets must be analyzed, sometimes in the petabyte range. This in turn implies that that the required number of computer processors processing the data may also be large so that the time taken to complete the machine learning data set task is acceptable. In addition, a common requirement for AI machine learning is that every processor used in a given analysis must analyze the whole data set.

The two requirements of a large data set and a large number of processors each able to analyze the entire data set is a major challenge facing the design of a machine learning HPC computer. A simplified HPC example is seen in FIG. 1 where multiple processors are interconnected using high speed serial interfaces such as Infiniband to large data storage devices such as Flash Arrays. The problem with the solution shown in FIG. 1 is that fast access to a large distributed data set stored on a network of storage servers which in turn is connected to a network of data processors servers can yield surprisingly low processing efficiency rates and be very expensive. These faults are caused by the significant time delays and wasted energy associated with the need to encode and decode the packets of data that are transmitted between the data storage and the data processors. In addition, the data storage and data processing solution of FIG. 1 has a significant layer of needless software management complexity that also needs to be addressed.

Another type of server addressing HPC computing includes a single server with one or two processors connected to a parallel array of storage nodes. This type of server typically includes a wide use of PCIE connections between the one or two processing CPU's connected to distributed modular storage. Although this results in a number of benefits including a large data set closely coupled to the data processors, the wide distribution of the PCIE buses, physically large CPU's, and the massive multiplexed DDR blocks create a heat intensive and complex hardware server, especially when placed in a 1U or 2U server.

Another problem with the HPC AI solutions just presented is the lack of modularity in the processing servers. This is important due to the varying types of data AI processing must analyze which is often best performed by various dedicated AI accelerator modules that typically include customized chip's on a modular card format such as M.2. Hence in considering a long term solution to HPC AI processing, it is wise to have data processing servers which provide a modular front end capable of holding AI accelerator modules.

What is presented in this patent is a new type of modular computer architecture for today's HPC and AI machine learning tasks that addresses the speed and power deficiencies of FIG. 1 using high density and super speed CPU's, provides for modular AI accelerators, includes stacked DDR memory, and 3D Flash memory storage modules coupled together in a new type of parallel array computer called a GAP server, packaged in a minimal height case suitable for use in today's server farms, resulting in a powerful HPC server with low latency, low energy usage, minimal cross network communication, and low TCO (Total Cost of Ownership).

### SUMMARY OF THE INVENTION

This invention describes a network topology called a GAP server which uses multiple arrays of processing and storage devices interacting in a single server. The Gap server can be viewed as a three tier system as shown in FIG. 2.

The first tier, TIER-1, the main GAP processor, PG, which connects to outside network devices, runs a GAP manager program, MG, and interfaces to an internal array of GAP nodes.

The second GAP tier, TIER-2, consists of Q number of GAP nodes, labeled N1 . . . NQ. Each GAP node has one processor, PX (where X=1, 2, . . . Q), and a node manager MX (where X=1, 2, . . . Q). For example, M1 runs under P1 on GAP node N1.

The third GAP tier, TIER-3, are device arrays connecting to the processing nodes, P1 . . . PQ, consisting of one or two types of devices consisting of Y processors, PXY (where Y=0, 1, 2, etc), and mass Z storage devices, SXZ (where Z=0, 1, etc.). The above collection of network elements may be networked in different ways yielding different GAP embodiments wherein the net goal is to support different types of allow read/wrote access to the SXZ data storage devices including exclusive read/write access (or “Disjoint Access”) by any of the processing engines, namely PG, PX, or PXY, to the mass storage devices, SXZ.

According to one aspect, a parallel computer architecture, GAP server, comprising a three tier system including: a first tier includes a main GAP processor, PG, which connects to outside network devices, runs a GAP manager program, MG, and interfaces to a second tier; a second tier including an array of GAP nodes wherein there are Q number of GAP nodes, labeled N1 . . . NQ, such that each GAP node has a processor, PX (where X=1, 2, . . . Q), an associated node manager MX (where X=1, 2, . . . Q), and interfaces to a third tier; the third tier including an array of devices including processing devices, PXY (where Y=0, 1, 2 etc), and mass Z storage devices, SXZ (where Z=0, 1, etc.), such that data access of any GAP processing devices, PG, PX, or PXY, may be granted data access to any GAP array storage device, SXZ, by the software managers MG in concert with MX.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear

FIG. 1 illustrates an example of a simplified HPC hyper scale computing network.

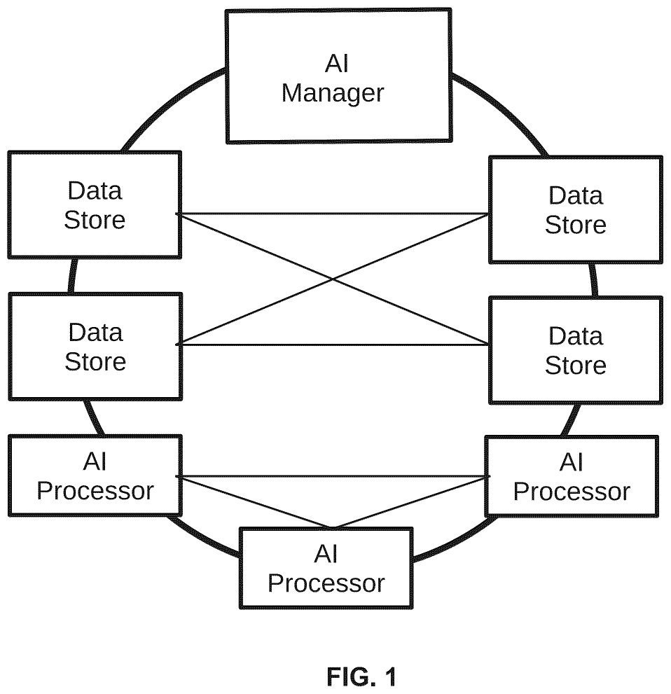

FIG. 2 illustrates a GAP Server in accordance with certain embodiments described herein;

FIG. 3 illustrates a serial GAP Node to Node Processor Connection in accordance with certain embodiments described herein;

FIG. 4 illustrates a Node to Node Cross-Point Switch Connection that connects GAP's Main Processor PG and all Node Processor PX in accordance with certain embodiments described herein; and

FIG. 5 illustrates a GAP CP3 Node Cross-Point Switch that for a given GAP Node, NX, connects the given Node Processors, PX and PXY to all of the Node Mass Storage SXZ devices in accordance with certain embodiments described herein.

### DETAILED DESCRIPTION

This invention describes a novel way to build an HPC type computer called a GAP (“Global Array Processor”) server suited for HPC computing tasks requiring fast storage and processing of large data sets such as used in AI machine learning or Big Data applications. In addition, the GAP design features both processor and data storage modularity which provides adaptability to different use cases and extended life usefulness.

The GAP server is a multi-tier parallel array computer with a main processing unit connected to a parallel array of processing nodes which each in turn have a secondary array of both storage devices and or processing devices wherein the software manager running on the main processing unit in concert with individual software managers running on the first array of processing units may grant exclusive or non-exclusive read/write access to storage devices on the secondary array to the main processing unit or any of the processing nodes on the secondary array.

Each GAP processing node is connected to a central processing unit which includes a GAP Manager that manages the processing nodes such that GAP processing devices including the central processing unit may be granted exclusive or non-exclusive read/write access to GAP node storage devices. We refer to this GAP attribute of exclusive read/write storage access by GAP processors as “Disjoint Storage”, i.e. “DAC”.

There are a number of benefits of Disjoint Storage. By granting exclusive data access to available storage segments by computing elements, the DAC and GAP architectures can avoid conflicting data access. This in turn results in more robust and faster processing that is free of data access collisions which can cause slowdowns or errors when multiple processors are attempting to access the same large data base.

This invention further describes a network topology called a GAP server which uses processing nodes with enhanced processing and storage attributes.

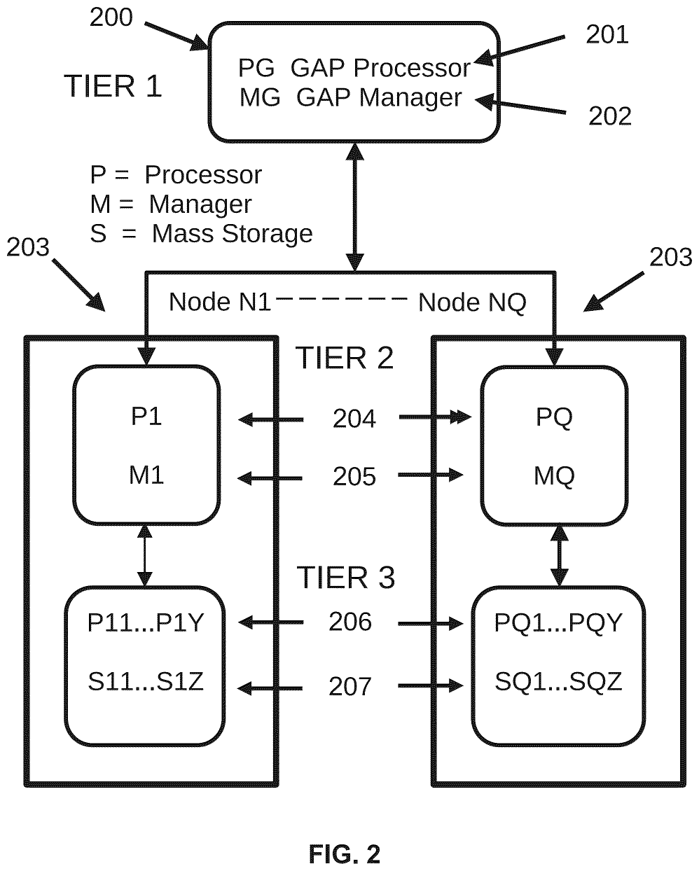

In an embodiment shown in FIG. 2, the present invention provides a parallel computer architecture including the following: a main computing element 200, including a PG GAP processor 201 and a MG GAP software manager 202; wherein PG 201 is connected to a parallel array of nodes NQ (where Q=1, 2, etc.) 203, wherein each node, NQ 203, includes a central processing element PQ 204, and a node manager MQ 205; in addition, each node processor PQ 204 connects to a second parallel array of nodes PQY (where Y=1, 2, etc. 206; and wherein each PQY array element is either a computing device, PQY 207, or storage device SQZ 208, such that the main MG manager 202 in concert with the MQ managers 205, may grant exclusive, (i.e., disjoint access) or non-exclusive data access to any SQZ.

As described above, the Gap server is a parallel array computer that can be viewed as a three tier system as shown in FIG. 2. The first tier (TIER 1) is the main GAP computer which consists of the processor, PG 201, and management software, MG 202, that interfaces to other outside network devices and to the GAP nodes. The second GAP tier (TIER 2) includes GAP nodes, N1-NQ 203 (where Q=1, 2, etc.). Each GAP node, N1-NQ 203, has one PQ 204 device which contains a node manager MQ 205 (e.g., M1 runs under P1 on GAP node N1). The third GAP tier (TIER 3) shown in FIG. 2 may include two types of devices physically existing on the N Gap nodes; namely “PQY” 206 processing engines and “SQZ” mass storage devices 207.

Another GAP server embodiment with node PXY processors and node SXZ storage devices share the same physical form factor as well as the same electrical interface. For example as seen in FIG. 2, if these two types of node devices, PQY 206 and SQZ 207, are made to the same M.2 physical card specification and share the same M.2 interface specification, then the GAP node PQY 206 and SQZ 207 devices may be easily changed to provide enhanced GAP server storage and or enhanced GAP server processing.

In one embodiment, the PQY processors are accelerators used in AI computers which, along with the SQZ storage devices such as M.2 SSD's, and E1.S and E.L storage devices, can be modular elements connected on node PX. Both M.2 NVME and E1 storage devices use the NVME interface.

In another GAP server embodiment, the GAP Manager and node PX processors are commercial CPU's while the GAP PXY processors are specialized AI processing accelerators. This embodiment is particularly suited for use in AI computing which can take many forms that are best handled by dedicated computing engines.

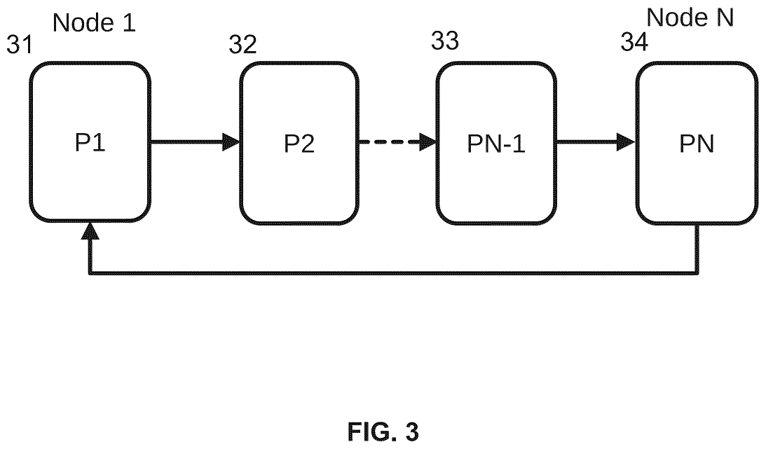

In another embodiment, a serial connection from one GAP Node to the next (P1 31, P2 32, PN−1 33, PN 34; N=1, 2, etc.) which is shown in FIG. 3 is used to allow all Nodes sequential access to all the data storage existing on all Gap nodes.

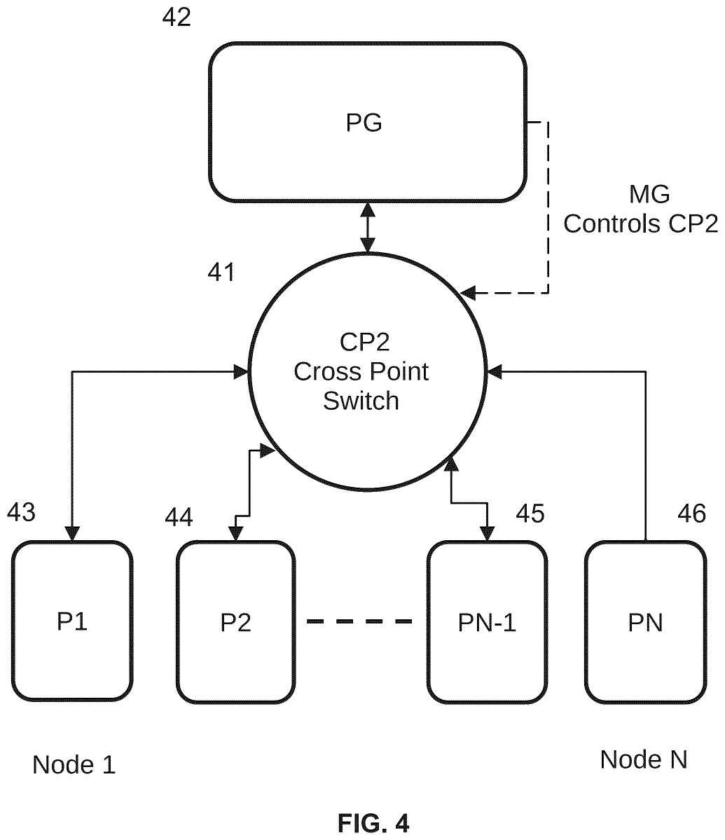

In another embodiment shown in FIG. 4 is a cross-point data switch labeled CP2 41 that connects any GAP processor, PG 42 or PX 43, 44, to any other PN 45, 46 processor. The cross-point switch allows CP2 41 allows fast data exchanges between GAP tier 1 and tier 2 devices.

Further, the embodiment as shown in FIG. 4 displays the use of a node to node cross point switch providing a node cross point switch controlled by the GAP manager that allows any PX processor a direct connection to any other PX processor rather than the round robin PX processor connection shown in FIG. 3.

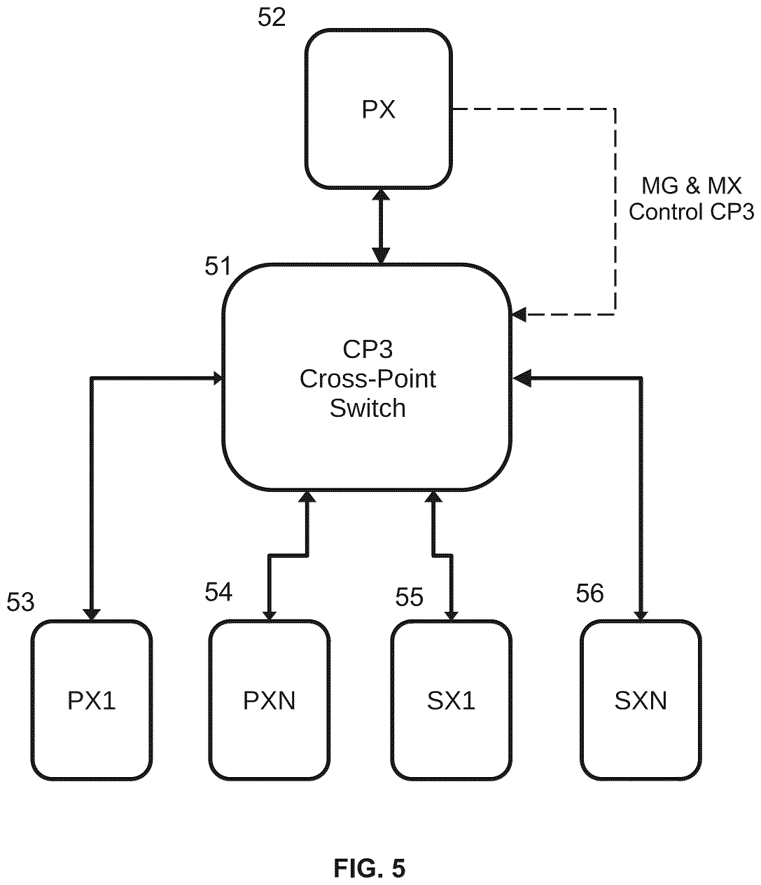

In another embodiment shown in FIG. 5 is a cross-point switch labeled CP3 51 that connects any GAP processor, PX 52 or PXN 53, 54, to any SXN 55, 56 storage device of the same X value and where the CP3 cross-point switch 51 is controlled by the GAP manager, MG, in concert with the node manager MX as designated in FIG. 5.

The CP3 cross-point switch 51 allows each GAP node to be considered as independent integrated task computing engine for tasks using only the node attached PX and PXN 53, 54 processors along with the SXN 55, 56 storage where X is a constant. In addition, the CP3 cross-point switch 51 allows rapid access of all node storage elements to any of the same node processing elements.

Another GAP server node embodiment allows each GAP node to have singularly enhanced node processing ability between its PX, PXY and SXZ devices which is a cross point switch. In FIG. 5, a cross point switch 51 is shown which allows any PX 52 or PXY (Y=1 . . . N) 53, 54 processor to directly address any SXZ (Z=1 . . . N) 55, 56 storage device on the same node. In this scenario, each GAP node can be viewed as a distinct processing and storage engine with its own set of processing and storage elements that is capable of very low processing latency.

A major characteristic of the GAP server is that each of its processing devices PX and PXY may be given exclusive access to any of the node storage devices SXZ. Although this access may be implemented by pure software means implemented using the GAP manager in concert with the GAP node managers, MX by adding various hardware methods to the GAP server similar to that described in previous paragraph above but existing as connections between the Gap PXN nodes. One such embodiment is shown in FIG. 5 which provides a simple one to one connection between adjacent GAP server nodes and between the first and last GAP server nodes. This connection can be implemented using various methods including USB or PCIE signal switches or optical serial devices.

Note that in any of the above schemes of connecting the various different GAP processing and storage devices, it is important to allow the GAP manager control of the connection process so that the overall operation of the various GAP processing can be controlled by a single source and monitored by the user.

An alternative solution for the sharing of the GAP resources among the GAP processing devices is to connect the GAP node processing and storage devices together using a local area Ethernet network. This has the advantage of providing a simple means of access by all of the processing and storage elements of the GAP server to each other.

A concept that is helpful to understand the GAP architecture is that of a “GAP User Data Storage Segment” or GUDS storage. A particular GUDS storage segment is that amount of user storage that is uniquely read/write accessible at any given time by only one GAP processor and therefore is the disjoint storage owned by a given GAP processor. This disjoint function is implemented by the GAP manager, MG, in concert with the GAP node managers, MQ, is a distinguishing feature of the GAP server.

Descriptions of various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. Further, modifications and variations may include combination of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A parallel computer architecture, GAP server, comprising a three tier system including:
a first tier includes a main GAP processor, PG, which connects to outside network devices, runs a GAP manager program, MG, and interfaces to a second tier;
a second tier including an array of GAP nodes wherein there are Q number of GAP nodes, labeled N1 . . . NQ, such that each GAP node has a processor, PX (where X=1, 2, . . . Q), an associated node manager MX (where X=1, 2, . . . Q), and interfaces to a third tier; and
the third tier including an array of devices including processing devices, PXY (where Y=0, 1, 2 etc), and mass Z storage devices, SXZ (where Z=0, 1, etc.), such that data access of any GAP processing devices, PG, PX, or PXY, may be granted data access to any GAP array storage device, SXZ, by the software managers MG in concert with MX.

2. The parallel computer architecture of claim 1,
wherein the data access of any of the GAP processing devices, PG, PX, or PXY, may be granted disjoint data access to any GAP array storage device, SXZ, by the software managers MG in concert with MX, and
wherein the disjoint data access includes exclusive read/write data access.

3. The parallel computer architecture of claim 1,
wherein the data access of any of the GAP processing devices, namely PG, PX, or PXY, may be disjoint data access to any GAP array storage device, SXZ, by the software managers MG in concert with MX, and
wherein the disjoint data access includes exclusive read/write access.

4. The parallel computer architecture of claim 1 which resides in a single server case.

5. The parallel computer architecture of claim 1 which includes serial connections between the linear array of second tier processors, PX, PX1, PX2, etc. such that adjacent array processors may sequentially transmit data between each other.

6. The parallel computer architecture of claim 5, wherein the serial connection includes an optical connection.

7. The parallel computer architecture of claim 1, further comprising a cross-point switch that is connected to all of the first tier and second tier processing devices, PG, PX, wherein any PG, PX, and PY devices with X≠Y may transmit data back and forth.

8. The parallel computer architecture of claim 1, further comprising a cross-point switch in the second tier that is connected to all second tier devices, PX, PXY, and SXZ with a same value of X, wherein any PX or PXY processing device may have disjoint access to any given SXZ.

9. The parallel computer architecture of claim 1, wherein super speed type 3 and type 4 USB gadget connections may be used to connect PG, PX, PXY, or SXZ to each other.

10. The parallel computer architecture of claim 1, wherein PCIE interconnects may be used to connect any of CP, PX, PXY, or SXZ to each other.

11. The parallel computer architecture of claim 1, wherein the NVME Express interface may be used to connect any of CP, PX, PXY, or SXZ to each other.

12. The parallel computer architecture of claim 1, wherein a serial optical or serial electrical interface may be used to connect any of CP, PX, PXY, or SXZ to each other.

13. The parallel computer architecture of claim 1, wherein the node processing device exists on an M.2 card format and may support the various M.2 USB, PCIE, and other interfaces.

14. The parallel computer of architecture claim 1, wherein the storage devices include E1.S or E1,L storage devices.

15. The parallel computer architecture of claim 1, wherein 3D Flash devices are used and placed on the parallel nodes (NX, where X=1, 2, etc.) to form the storage, (SXW, W1,3, etc.).

16. The parallel computer architecture of claim 1, wherein Ethernet connections may be used to connect node processors (PX, where X=1, 2, etc.) to secondary node processors (PXY, where Y=1, 2, etc., & X is fixed) and secondary storage devices (SXZ, where Z=1, 2, etc. & X is fixed), thereby P1 being able to connect using Ethernet to (P11, P12, S11, S12) but not to (P21, P22, S21, S22).
